(19) United States
(12) Patent Application Publication
(10) Pub. No.: US 2003/0218544 A1
(43) Pub. Date: Nov. 27, 2003

(54) Steering apparatus, apparatus of detecting condition and method of detecting condition of mobile body

(76) Inventor: Akira Shinada, Tokyo (JP)

Correspondence Address: William S. Frommer, Esq., FROMMER LAWRENCE & HAUG LLP, 745 Fifth Avenue, New York, NY, 10151, US

(21) Appl. No.: 10/367,336

(22) Filed: Feb. 14, 2003

(30) Foreign Application Priority Data
Feb. 19, 2002 (JP) 2002-040996

(51) Int. Cl. G08B 23/00

(52) U.S. Cl. 340/575; 340/576

(57) ABSTRACT

The invention relates to a steering apparatus, an apparatus of detecting condition and a method of detecting a condition of a mobile body, which are applicable to an automobile, for example, so as to solve uncomfortableness of a driver, while accuracy in detection can be improved when tension of the driver is detected in accordance with perspiration of the driver. According to the invention, plural air outlets for blowing air to a palm side are provided at a portion held by a hand.

### BACKGROUND OF THE INVENTION

1. Field of the Invention

The present invention relates to a steering apparatus, an apparatus of detecting condition and a method of detecting a condition of a mobile body, which are applicable to an automobile, for example. In accordance with the invention, a plurality of air outlets through which air blows toward a palm of an driver are provided at a portion held by a hand so as to solve uncomfortableness of the driver, while accuracy in detection is improved when tension of the driver is detected in accordance with perspiration of the driver.

2. Description of the Related Art

A steering apparatus of an automobile is conventionally arranged to be steered by both hands in general. A joystick type of steering apparatus, which can be steered by a single hand, is conventionally applicable to a definite automobile for disabled persons.

As for such steering apparatus, a method of detecting a pulse rate for the purpose of being helpful to drive is proposed in JP-A-2000-23929, for example. In JP-A-5-42875, proposed a method of providing a humidity sensor to detect perspiration of a driver in order to detect tension of the driver.

### SUMMARY OF THE INVENTION

Such steering apparatus, however, is moisturized due to adhesion of sweat of a driver, and thereby, dust would be easily adhere to the apparatus, so that the apparatus would be further moisturized. Especially, in a steering apparatus in which a portion for gripping is fixed in a given position such as a joystick type of steering apparatus, a user always puts his or her hand on a specific position, so that the position is easily moisturized.

Such moisture not only makes a driver uncomfortable but also deteriorates accuracy in detection when condition of the driver is detected in accordance with perspiration of the driver.

In view of the above problem, an object of the invention is to provide a steering apparatus, which can solve the uncomfortableness of a driver and improve accuracy in detection when tension of the driver is detected in accordance with perspiration of the driver, an apparatus of detecting condition using a structure of the steering apparatus and a method of detecting condition.

In order to solve the problem, in an aspect of the invention, there is provided a steering apparatus of a mobile body in which a portion held by a user's hand is fixed in a given position, comprising plural air outlets for blowing air to a palm side of a user's hand, the air outlets being provided at the portion held by the hand.

In another aspect of the invention, provided an apparatus of detecting condition comprising: an air outlet for blowing air to a palm side of a user's hand, the air outlet being provided at a portion held by the user's hand; and a determination unit for determining condition of a user by comparing a result of detection of temperature and humidity by outlet side temperature and humidity sensors with a result of detection of temperature and humidity by inlet side temperature and humidity sensors.

In further another aspect of the invention, provided a method of detecting condition, comprising: a step of blowing air to a palm side of a user's hand through an air outlet provided at a portion held by the user's hand; and a step of detecting perspiration of a user by comparing temperature and humidity of the air to be blown to the palm side through the air outlet with temperature and humidity of the air having been blown to the palm side.

According to the structure of the first aspect of the invention, in a steering apparatus of a mobile body in which a portion held by a user's hand is fixed in a given position, comprising plural air outlets for blowing air to a palm side, the air outlets being provided at the portion held by the hand, the air to be blown though the plural air outlets promotes drying of the portion held by a user's hand. Therefore, the humidity of the portion held by a user's hand can be reduced, which can solve uncomfortableness of a driver, and accuracy in detection can be improved when tension of the driver is detected in accordance with perspiration of the driver.

According to the structure of the second aspect of the invention, in an apparatus of detecting condition comprising an air outlet for blowing air to a palm side, the air outlet being provided at the portion held by a user's hand, the air to be blown through the air outlet promotes drying of the portion held by a user's hand, so that the humidity of the portion held by a user's hand can be reduced. Therefore, uncomfortableness of a driver can be solved and accuracy in detection can be improved when tension of the driver is detected in accordance with perspiration of the driver. Further, in an apparatus of detecting condition comprising a determination unit for determining condition of a user by comparing a result of detection of temperature and humidity by outlet side temperature and humidity sensors with a result of detection of temperature and humidity by inlet side temperature and humidity sensors, even when the temperature and humidity of the air to be blown to the hand are variously different, variation of the moisture quantity in the air having been blown to the hand can be detected with accuracy and degree of the perspiration can be detected in accordance with the variation of the moisture quantity. The degree of the perspiration can thus allow condition of a user to be determined with high accuracy.

Accordingly, accuracy in detection can be further improved when tension of the driver is detected in accordance with perspiration of the driver.

According to the structure of the third aspect of the invention, it is possible to provide a method of detecting condition in which uncomfortableness of a driver can be solved and accuracy in detection can be improved when tension of the driver is detected in accordance with perspiration of the driver.

### BRIEF DESCRIPTION OF THE DRAWINGS

The above and further objects and novel features of the invention will more fully appear from the following detailed description when the same is read in connection with the accompanying drawings in which:

FIG. 1 is a schematic diagram showing a steering apparatus according to an embodiment of the invention;

FIG. 2 is a side view of a steering apparatus shown in FIG. 1;

FIG. 3 is a plane view of a controlling portion of a steering apparatus shown in FIG. 2;

FIG. 4 is a plane view of a grip portion of a controlling portion shown in FIG. 3;

FIG. 5 is a graph of characteristic curves showing variations in moisture quantity; and

FIG. 6 is a flowchart showing a process carried out by a central processing unit in a steering apparatus shown in FIG. 1.

### DETAILED DESCRIPTION OF THE INVENTION

Embodiments of the invention will be now described in detail, made reference to the drawings.

(1) Structure of Embodiment

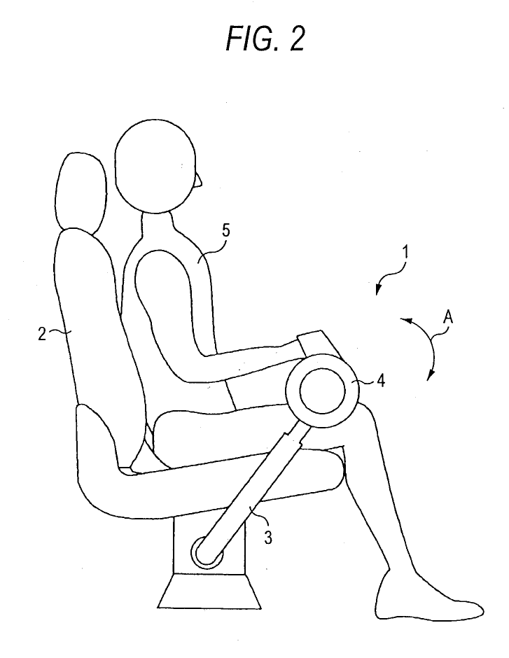

FIG. 2 is a side view showing a relation between a seat and a steering apparatus according to an embodiment of the invention. A steering apparatus 1 has a portion for gripping, which is fixed to a given position, as well as a joystick type of steering apparatus and is applicable to an automobile, for example. In the steering apparatus 1, an arm 3 extends from a right-hand bottom of a driving seat 2 and a controlling portion 4 is provided on the top of the arm 3.

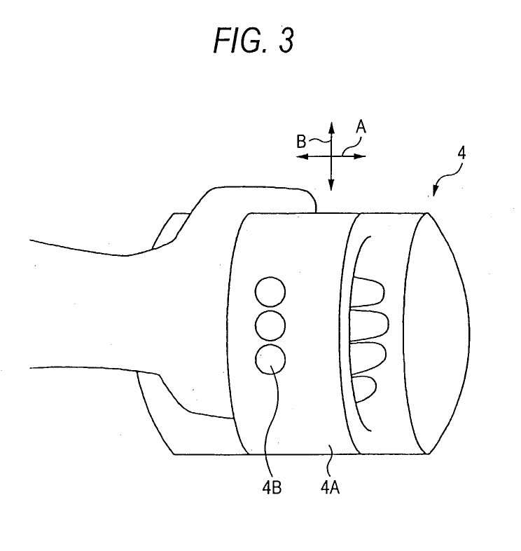

A driver 5 sitting on the seat 2 handles the controlling portion 4 with his or her right hand. As shown in a magnified top view in FIG. 3, the controlling portion 4 is arranged to be able to rotate front and back as shown by an arrow A about a rotation shaft, which is provided at the top of the arm so as to extend almost horizontally. In an automobile in which the steering apparatus 1 is applied, the front and back rotation allows the automobile to speed up or slow down. Furthermore, the controlling portion 4 is arranged to be able to rotate right and left as shown by an arrow B about the bottom of the arm 3. In an automobile in which the steering apparatus 1 is applied, the right and left rotation allows a direction of front wheels of the automobile to change right or left, so that the automobile can change its moving direction.

The controlling portion 4 has an upper portion 4A rising in an arc shape so that there would be formed a space with a rough arc on its upper side from the front view of the controlling portion 4. A driver can put his or her index finger to little finger in the space with an arc so that roots of his or her thumb and index finger would touch a bottom part of the rose arc portion 4A. When a driver uses his or her thumb and index finger to give force against the rose arc portion 4A in the right or left direction, the controlling portion 4 enables the right and left rotation as a whole. When a driver uses his or her roots of his or her thumb and index finger to push the rose arc portion 4A front, the controlling portion 4 enables the front rotation as a whole. In the controlling portion 4, it is arranged that the rose arc portion 4A cover a back of a driver's hand while a controlling element 4B of a horn be provided above the back of the hand.

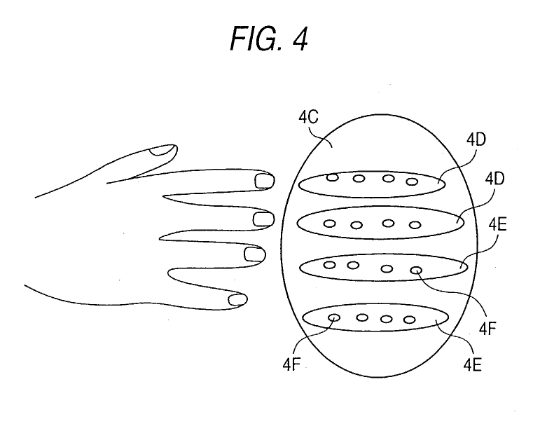

As shown in FIG. 4 comparatively with FIG. 3, in the controlling portion 4, is formed under the rose arc portion 4A a roughly ellipse shape of convex grip portion 4C for gripping with an index finger to a little finger. Gripping the grip portion 4C allows the controlling portion 4 to be moved back.

The grip portion 4C is provided at respective portions for respective fingers with grooves 4D, which guide respective fingers so that respective fingers can be smoothly placed. Each groove 4D is provided in series with small holes, which are allocated to an air outlet 4E and an air inlet 4F in order. The air outlet 4E is a small hole provided in the grip portion 4C held by a hand. Air blows toward a palm of a hand holding the grip portion 4C through the air outlet 4E. The air inlet 4F is a small hole for leading the air having been blown as described above to the inside of the grip portion 4C. In the steering apparatus 1, these plural air outlets 4E and air inlets 4F are respectively provided in the grooves 4D in turn. Thus, air can blow a driver's hand through any air outlet 4E even when a driver strongly grips the grip portion 4C, while the air having been blown as described above can be lead to the inside through any air inlet 4F. In the steering apparatus 1, the air outlets 4E and air inlets 4F contribute not only to solve uncomfortableness of a driver but also to detect condition of a driver's hand.

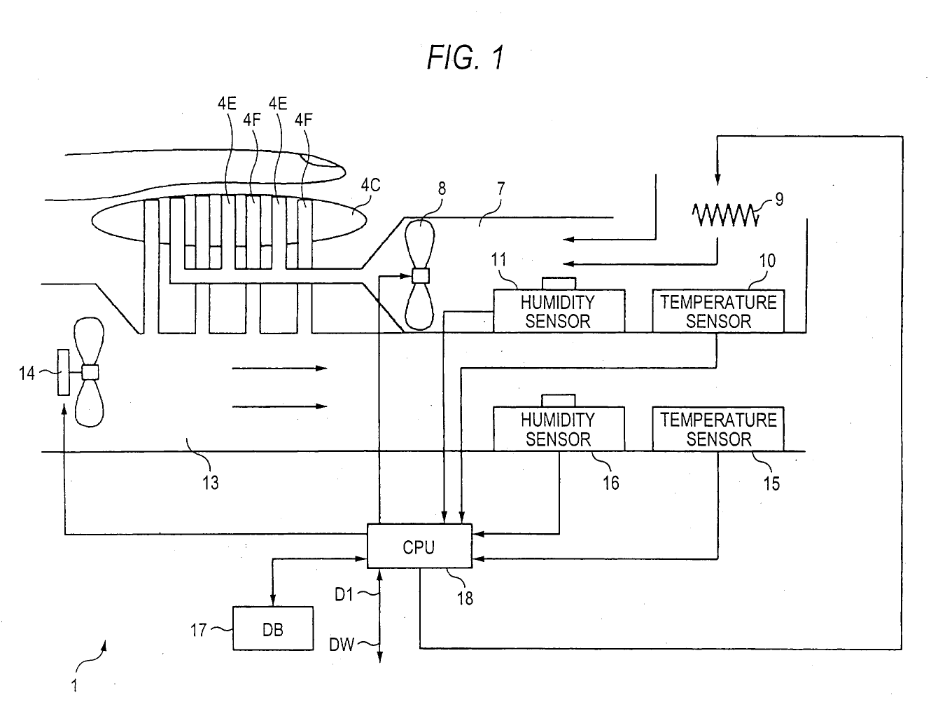

FIG. 1 is a schematic diagram showing air outlets 4E and air inlets 4F in the steering apparatus 1 with their surroundings. In the steering apparatus 1, the air outlets 4E are connected to a duct 7, which is an air-flowing path. The duct 7 is provided with a fan 8 for blowing air to the air outlets 4E and a heater 9 for heating the air to be blown to the air outlets 4E. Thus, in the steering apparatus 1, the fan 8 can operate to blow air through the air outlets 4E so as to dry the grip portion 4C, and thereby, further dry a hand put on the grip portion 4C. The heater 9 can also operate with the fan 8 to warm up the air to be blown through the air outlets 4E so as to speed up the dry of the grip portion 4C and a hand put on the grip portion 4C as well as to warm the grip portion 4C.

In the steering apparatus 1, a temperature sensor 10 and a humidity sensor 11 are provided in the duct 7 so as to be able to detect temperature and humidity of the air to be blown through the air outlets 4E.

On the other hand, the air inlets 4F are connected to a duct 13, which is an air-flowing path, in the steering apparatus 1. The duct 13 is provided with a fan 14 for inducting air through the air inlets 4F. Accordingly, it is arranged in the steering apparatus 1 that the air having been blown to a hand through the air outlets 4E be inducted from the air inlets 4F.

The duct 13 is further provided with a temperature sensor 15 and a humidity sensor 16 so as to be able to detect temperature and humidity of the air to be inducted through the air inlets 4F. Thus, it is possible to compare a result of the detection by means of the temperature sensor 10 and the humidity sensor 11, which are provided on the air outlets 4E side, with a result of the detection by means of the above-mentioned temperature sensor 15 and humidity sensor 16 so as to detect variation in moisture quantity included in the air having been blown to a hand trough the air outlets 4E.

In the steering apparatus 1, perspiration of a driver is detected on the basis of the above-mentioned variation in moisture quantity. Degree of tension, which is one of condition of a driver, is detected in accordance with variation in perspiration of a driver. In a data base (DB) 17, an action of an automobile to which the steering apparatus 1 is mounted and an operation of a driver for a predetermined period just before the degree of tension significantly increases are recorded in conjunction with a possible cause of the significant increase of the degree of tension. The data base 17 is formed by recording various kinds of information D1 obtained from a controller of the automobile. The information D1 comprises information relating to an action of an automobile such as direction or speed of the automobile, for example, information relating to operation of an automobile such as operation of the steering apparatus 1, a wiper and a light, for example, and information enabling determination of degree of fatigue of a driver such as a running period from a start of running.

Accordingly, in the case that tension of a driver is detected, comparison with a record of the data base 17 allows a cause of the tension to be searched in the steering apparatus 1. The data base 17 is arranged in the initial condition to be capable of recording normal information relating to driving operation such as sudden braking and sudden turning of the wheel.

A central processing unit (CPU) 18 is a controller for controlling an operation of the steering apparatus 1. The central processing unit 18 carries out a process recorded in a memory not shown to process results of detection by means of the temperature sensors 10 and 15 and the humidity sensors 11 and 16 so as to determine condition of a driver. That is to say, the central processing unit 18 is connected to a controller of an automobile to which the steering apparatus 1 is mounted to obtain from the controller information D1 relating to an action and operation of the automobile.

In accordance with the information D1 relating to an operation, the central processing unit 18 starts the fans 8 and 14 when a driver starts the engine, so that air would be blown through the air outlets 4E as well as air would be inducted though the air inlets 4F. Moreover, at predetermined time intervals, the temperature and the humidity of the air to be blown through the air outlets 4E are detected by means of the temperature sensor 10 and the humidity sensor 11 provided on the air outlets 4E side, while the temperature and the humidity of the air to be inducted from the air inlets 4F are detected by means of the temperature sensor 15 and the humidity sensor 16 provided on the air inlets 4F side.

The central processing unit 18 detects the perspiration quantity of a driver's hand on the basis of the so-detected temperature and humidity of the air on the air outlets 4E side and the air inlets 4F side. That is, the central processing unit 18 uses a result of the temperature and humidity measurement, for example, makes reference to a table, and thereby, detects the moisture quantity included in a unit volume of the air to be blown through the air outlets 4E and the air to be inducted through the air inlets 4F, respectively. The central processing unit 18 further calculates a differential value between the moisture quantities in order to detect the moisture quantity, which is increased due to a driver's hand put on the grip portion 4C and included in the air.

As described above, the steering apparatus 1 is arranged to be able to measure the perspiration quantity of a driver with significantly higher accuracy than a conventional manner so as to detect driver's condition in accordance with a result of the perspiration measurement. That is to say, only providing a humidity sensor in the vicinity of a driver's hand also allows the perspiration quantity of a driver to be measured. In such structure, however, change in humidity in the air also influences a result of the measurement. In order to solve this problem, the steering apparatus 1 measures the perspiration quantity by comparison between the air to be blown to a hand and the air having been moisturized by the hand. The perspiration measurement thus can be carried out while humidity in the air can be effectively prevented from influencing the measurement, so that the accuracy in measurement can be improved.

Furthermore, in measuring the perspiration quantity by comparison between the air to be blown to a hand and the air having been moisturized by the hand, temperature and humidity are respectively measured to calculate the moisture quantity, which is compared to measure the perspiration quantity. Then, accuracy deterioration in measurement due to difference in temperature between the air to be blown to the hand and the air having been moisturized by the hand can be effectively prevented from occurring. That is, a humidity value is different when the temperature is different even in the case that the moisture quantity included in the air is same. The humidity is low when the temperature is high even in the case that the moisture quantity included in the air is much. Especially in the case of heating the air to be blown to a hand by means of the heater 9 like the steering apparatus 1, it is considered that the difference in temperature between the air to be blown to the hand and the air having been moisturized by the hand would be remarkable. In view of the above, in the embodiment, the temperature and the humidity in the air to be blown to the hand and the air having been moisturized by the hand are respectively measured to calculate the moisture quantities, which are compared to measure the perspiration quantity, so that accuracy in measurement can be improved.

The central processing unit 18 compensates a differential value of the moisture quantity so calculated in accordance with the temperature and humidity in the air to be blown to a hand, and thereby, detects the perspiration quantity of a driver. The compensation of the differential value is calculated by multiplying the differential value by a coefficient, which is recorded in a table and detected in accordance with the temperature and humidity in the air to be blown to a hand. In the atmosphere in which the humidity is high, the moisture quantity to be evaporated into the air is little even when a driver's hand perspires, while in the atmosphere in which the humidity is low, the moisture quantity to be evaporated into the air is much. Thus, in the steering apparatus 1, in consideration of the above, a result of the measurement is compensated in accordance with data recorded in advance in the above-mentioned table to compensate the moisture quantity varying in accordance with such atmosphere, so that the perspiration quantity of a driver's hand would be measured with further higher accuracy.

The central processing unit 18 detects the perspiration quantity of a driver's hand on the basis of the so-detected differential value of the moisture quantity and further monitors the perspiration so as to detect variation of the perspiration quantity. In this process, the central processing unit 18 calculates a running average of the so-detected differential value of the moisture quantity in accordance with a predetermined measuring period and sets a threshold value on the basis of the running average value to determine the perspiration quantity.

Thus, the central processing unit 18 is arranged to properly set a reference value for determination in accordance with the personal difference, for example, to detect variation of the perspiration quantity, so that an error in determination due to the personal difference can be effectively prevented.

The perspiration quantity varies according to a change of a driver's condition. Especially a change in emotion greatly influences perspiration. For example, the perspiration quantity remarkably increases when a driver gets angry or is at tension. A change in health of a driver also influences the perspiration quantity.

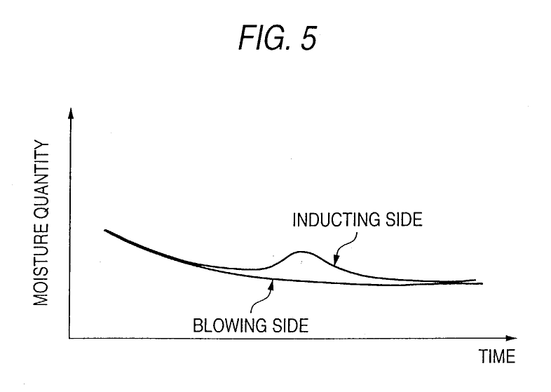

FIG. 5 is a graph of characteristic curves in measuring the moisture quantity included in the air on the air outlet 4E side and the air inlet 4F side, respectively. When a driver becomes at tension because of necessity of a driving operation such as sudden braking at a predetermined point, the perspiration quantity increases, and thereby, the moisture quantity in the air on the air inlet 4F side increases more than that of the air outlet 4E side.

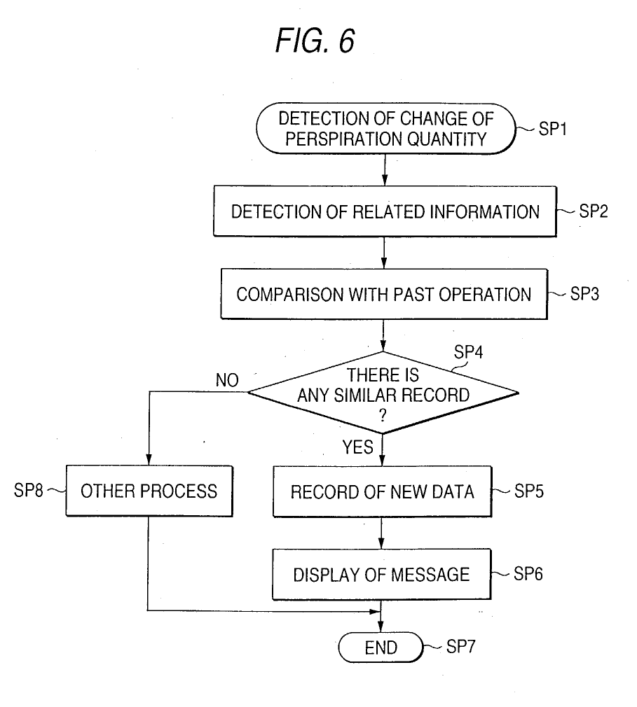

The central processing unit 18 monitors variation of the perspiration quantity, determines that degree of tension of the driver has increased when the perspiration quantity increases, and then, carries out a process shown in FIG. 6. After starting the process, the central processing unit 18 advances the process from Step SP1 to Step SP2 to select information possibly relating to the increase of the perspiration quantity from information D1 available from a controller of an automobile to which the steering apparatus 1 is mounted. The information so selected is information relating to a sudden operation in operating the steering apparatus 1 such as sudden turning of the wheel and sudden braking, information relating to a time period from the start of driving and the like.

The central processing unit 18 retrieves the data base 17 on the basis of the so-selected information to compare it with past record in a following step SP3. In Step SP4, it is determined whether there is similar record or not. If “YES”, it is considered that the driver becomes at tension due to sudden braking, sudden turning of the wheel or such, and then, the process goes to Step 5 so that the selected information would be additionally recorded in the data base 17. In recording in the data base 17, the central processing unit 18 records such information with classification of a cause same as the similar record.

The central processing unit 18 thus infers a cause of increase of the tension by accessing the data base 17. The record of the selected information in the data base 17 also contributes to reflect personality of a driver in record of the data base 17, so that this kind of inference would be more reliable.

The central processing unit 18 then advances the process to Step SP6 to output warning information DW to a controller of the automobile on the basis of a cause of the tension increase detected by referring to the data base 17 and provides a message for calling driver's attention through a display unit or a sound output unit of the automobile. Namely, a message of “Be careful. You have suddenly turned the wheel,” for example, is provided when the cause is sudden turning of the wheel. Moreover, when it is determined in accordance with information relating to a time period from the start of driving that a driver continuously drives for a long time, a message for advising a driver to take a rest is provided.

After completing the above series of steps, the central processing unit 18 advances the process to Step SP7 to end the process.

On the other hand, when the result is “NO” in Step SP4, the central processing unit 18 advances the process from Step SP4 to SP8. In this case, it is considered that a cause of the increase of the perspiration quantity may be a change in health of a driver, anger of a driver due to conversation with a passenger or such since there is no similar situation found by referring to the data base 17 although the perspiration quantity of the driver increases.

Accordingly, in Step SP8, the central processing unit 18 monitors an operation by the driver and perspiration of the driver for a predetermined time period after the perspiration has once increased. When an operation by the driver does not change at all and variation of the perspiration becomes steady, it can be determined that the driver returned to normal condition. Then, the central processing unit 18 advances the process from Step SP8 to Step SP7 to end the process.

When an operation by the driver changes and the perspiration quantity continuously increases to the contrary, it can be considered that the driver's health suddenly changes and does not return to normal condition. In this case, the central processing unit 18 determines that driving by the driver is danger and advises the driver to stop driving via a message or a sound. Further, the central processing unit 18 informs a person in a contact place recorded in advance of abnormality via a line of a portable phone when the perspiration quantity is extremely much and the operation is also remarkably unstable. After these steps, the central processing unit 18 advances the process to Step SP7 to end the process.

In parallel with the above process, the central processing unit 18 examines a result of the temperature detection by means of the temperature sensor 10 provided on the air outlet 4E side on the basis of a predetermined reference value for determination to determine whether or not the grip portion 4C is unusually cold. When the result of the temperature detection by means of the temperature sensor 10 is the above reference value or less, the central processing unit 18 determines that the grip portion 4C is remarkably cold and starts operation of the heater 9. In this manner, the central processing unit 18 blows the air heated by the heater 9 through the air outlet 4E by means of the fan 8 to warm the grip portion 4C.

(2) Operation of Embodiment

In the above-described structure of the steering apparatus 1 (shown in FIGS. 2 and 3), the front-back and right-left operation of the controlling portion 4 allows a direction of an automobile to be changed and speed thereof to be accelerated or throttled. In such steering apparatus 1, putting a hand on the grip portion 4C can operate the controlling portion 4. The grip portion 4C is provided with the guide grooves 4D for leading fingers thereon (shown in FIG. 4), so that a portion for gripping would be fixed at a given position and only a definite portion is always gripped.

Such steering apparatus 1 causes sweat to be adhered, and thereby, further causes dust to be adhered, and therefore, is unsanitary as well as easy to bear humidity.

In order to solve such problem, in the steering apparatus 1, plural air outlets 4E are provided in the grooves 4D for guiding fingers. Air is blown through the air outlets 4E toward a palm side by driving the fan 8 (shown in FIG. 1). The palm side of the grip portion 4C in the steering apparatus 1 is then dried and uncomfortable humidity is removed. The steering apparatus 1 can thus solve uncomfortableness of a driver.

Furthermore, accuracy in detection can be improved when the perspiration of a hand is detected.

In the steering apparatus 1, humidity is removed as described above while the temperature of the air to be blown to a hand is detected by means of the temperature sensor 10, so that the heater 9 would heat the air to be blown to a hand when the detected temperature is low. The steering apparatus 1 thus allows humidity to be certainly removed by blowing a warm wind even when it is difficult to remove the humidity only by blowing normal air. Furthermore, the grip portion 4C can be immediately warmed when it is cold, so that operational performance by a driver can be improved.

In the steering apparatus 1, in parallel with the above-described process, the temperature and the humidity of the air to be blown to a hand are detected by means of the temperature sensor 10 and the humidity sensor 11 while the temperature and the humidity of the air having been blown to a hand are detected by means of the temperature sensor 15 and the humidity sensor 16. On the basis of the comparison between the detected temperature and humidity of the air to be blown to a hand and those of the air having been blown to a hand, the central processing unit 18 detects the perspiration quantity of a driver with high accuracy. That is, the central processing unit 18 detects the moisture quantity of the air to be blown to a hand and that of the air having been blown to a hand, respectively, on the basis of the so-detected temperature and humidity, to detect a differential value of the moisture quantities. In the steering apparatus 1, the perspiration quantity is detected on the basis of the differential value. The perspiration quantity can be measured with influence by humidity of the air to be blown to a hand and by difference in temperature between the air to be blown to a hand and the air having been blown to a hand being effectively prevented. The accuracy in measurement is thus improved.

Further, in the steering apparatus 1, the differential value detected as described above is compensated in accordance with the temperature and humidity of the air to be blown to a hand, and thereby, variation in degree of drying of sweat influenced by temperature and humidity is compensated, so that accuracy in measuring the perspiration quantity would be improved.

In the steering apparatus 1, a threshold value is set on the basis of a running average value of the so-compensated differential value while variation of the so-compensated differential value is determined on the basis of the threshold value, so that increase of the perspiration quantity would be detected.

In the steering apparatus 1, a cause of increase of the perspiration quantity is inferred by referring to a record of the data base 17 when such increase of the perspiration quantity is detected. In the case that the cause comes from driving, a warning is given to a driver. Accordingly, it is possible in the steering apparatus 1 to detect variation of the perspiration quantity with high accuracy, and thereby, a warning can be given to a driver at a proper timing, which contributes to safety drive.

(3) Effect of Embodiment

In accordance with the above-described structure, plural air outlets for blowing air to a palm side are provided on a portion held by a hand so as to prevent the portion held by a hand from getting humid, which solves uncomfortableness of a driver, and accuracy in detection can be improved in the case that the tension of a driver is detected in accordance with perspiration of the driver.

Moreover, providing a heater for heating the air to be blown through the air outlet can promote drying of a portion held by a hand, which further solves uncomfortableness of a driver. Accuracy in detection can be also improved in the case that the tension of a driver is detected in accordance with perspiration of the driver. Further, the portion held by a hand can be warmed, so that operational performance by a driver can be improved.

Blowing air to a driver's palm side through an air outlet provided at a portion held by a driver's hand, comparing the temperature and humidity between the air to be blown through the air outlet and the air having been blown, and thereby, detecting perspiration of a driver allow the perspiration quantity to be detected with higher accuracy than a conventional manner.

The tension of a driver can thus determined in accordance with variation of the perspiration quantity, so that degree of the tension can be determined with higher accuracy.

Furthermore, determination of tension of a driver by detecting increase of the perspiration quantity to infer a cause of the increase can effectively contribute to a safety drive.

(4) Other Embodiments

In the above embodiment, a warning is given to a driver in accordance with determination of the perspiration quantity. The invention is, however, not limited to the above. A result of the determination may be variously used such as for controlling the room temperature, for example.

In the above embodiment, the perspiration quantity is detected by comparing the temperature and humidity between the air to be blown to a hand and the air having been blown to a hand. The invention is, however, not limited to the above. The perspiration quantity may be detected, made reference to the room temperature and humidity, since the perspiration quantity increases when the room temperature and humidity is high.

In the above embodiment, the invention is applied to a steering apparatus controlled by a hand putting on the grip portion 4C covered by the arc portion 4A. The invention is, however, not limited to the above and can be widely applied to various kinds of steering apparatus in which a potion held by a driver's hand is fixed to a given position such as a joystick type of steering apparatus so long as the steering apparatus comprises plural air outlets.

In the above embodiment, the invention is applied to a steering apparatus in which a potion held by a driver's hand is fixed to a given position. The invention is, however, not limited to the above. The invention can be widely applied to various shapes of steering apparatus such as a ring-shaped steering apparatus so long as the steering apparatus has a structure that the perspiration quantity is detected by comparing the temperature and humidity between the air to be blown to a hand and the air having been blown to a hand.

In the above embodiment, the invention is applied to a steering apparatus of an automobile. The invention is, however, not limited to the above. The invention can be widely applied to a steering apparatus of various kinds of mobile body such as a truck and an aircraft, and further, a steering apparatus of a mobile body relating to a game device or a simulation device.

As described above, according to the invention, plural air outlets for blowing air to a palm side are provided at a portion held by a hand for the purpose of solving uncomfortableness of a driver and accuracy in detection is improved in the case of detecting tension of a driver on the basis of the perspiration quantity of the driver.

What is claimed is:

1. A steering apparatus of a mobile body in which a portion held by a user's hand is fixed in a given position, comprising plural air outlets for blowing air to a palm side, the air outlets being provided at the portion held by the hand.

2. A steering apparatus of a mobile body according to claim 1, comprising
a heater for heating the air to be blown through the air outlets.

3. A steering apparatus of a mobile body according to claim 1, comprising:
plural air inlets for inducting the air having been blown through the air outlets;
outlet side temperature sensor for detecting temperature of the air to be blown through the air outlets;
an outlet side humidity sensor for detecting humidity of the air to be blown through the air outlets;
an inlet side temperature sensor for detecting temperature of the air to be inducted through the air inlets;
an inlet side humidity sensor for detecting humidity of the air to be inducted through the air inlets; and
a determination unit for determining condition of a user by comparing a result of the detection of temperature and humidity by the outlet side temperature and humidity sensors with a result of the detection of temperature and humidity by the inlet side temperature and humidity sensors.

4. A steering apparatus of a mobile body according to claim 3, wherein determination of the condition by the determination unit is determination of tension of the user on the basis of variation of perspiration quantity of the user's hand.

5. A steering apparatus of a mobile body according to claim 4, wherein the determination unit detects increase of the perspiration quantity and infers a cause of the increase of the perspiration quantity.

6. An apparatus of detecting condition comprising:
an air outlet for blowing air to a palm side of a user's hand, the air outlet being provided at the portion held by the user's hand;
an air inlet for inducting the air having been blown through the air outlet;
an outlet side temperature sensor for detecting temperature of the air to be blown through the air outlet;
an outlet side humidity sensor for detecting humidity of the air to be blown through the air outlet;
an inlet side temperature sensor for detecting temperature of the air to be inducted through the air inlet;
an inlet side humidity sensor for detecting humidity of the air to be inducted through the air inlet; and
a determination unit for determining condition of a user by comparing a result of the detection of temperature and humidity by the outlet side temperature and humidity sensors with a result of the detection of temperature and humidity by the inlet side temperature and humidity sensors.

7. A method of detecting condition, comprising:
a step of blowing air to a palm side of a user's hand through an air outlet provided at a portion held by the user's hand;
and a step of detecting perspiration of a user by comparing temperature and humidity of the air to be blown to the palm side through the air outlet with temperature and humidity of the air having been blown to the palm side.
